(19) United States
(12) Patent Application Publication
(10) Pub. No.: US 2014/0001911 A1
(43) Pub. Date: Jan. 2, 2014

(54) ROTOR ASSEMBLY

(71) Applicant: ZHONGSHAN BROAD-OCEAN MOTOR CO., LTD., Zhongshan (CN)

(72) Inventors: Songfa TANG, Zhongshan (CN); Chongsheng ZENG, Zhongshan (CN)

(73) Assignee: ZHONGSHAN BROAD-OCEAN MOTOR CO., LTD., Zhongshan (CN)

(21) Appl. No.: 13/844,047

(22) Filed: Mar. 15, 2013

(30) Foreign Application Priority Data
Jun. 29, 2012 (CN) 201220314778.6

(51) Int. Cl. H02K 1/27

(52) U.S. Cl. CPC H02K 1/2773
USPC 310/156.56

(57) ABSTRACT

A rotor assembly, including: a permanent magnet, a rotor core, and a magnetic loop. The rotor core includes an annular ring including a central axial bore, and a plurality of magnetic induction blocks protruding outward from an outer side of the annular ring. A through hole is arranged on the magnetic induction block. A radial recess is formed between every two adjacent magnetic induction blocks for mounting the permanent magnet. An end plate and a base plate are disposed on an end surface and a bottom surface of the rotor core by injection molding, respectively. A connecting column passes through the through hole and connects the end plate and the base plate as a whole body. An end surface of the end plate protrudes upward to form a magnetic loop bracket. The magnetic loop is disposed on the magnetic loop bracket.

### CROSS-REFERENCE TO RELATED APPLICATIONS

Pursuant to 35 U.S.C. §119 and the Paris Convention Treaty, this application claims the benefit of Chinese Patent Application No. 201220314778.6 filed Jun. 29, 2012, the contents of which are incorporated herein by reference. Inquiries from the public to applicants or assignees concerning this document or the related applications should be directed to: Matthias Scholl P.C., Attn.: Dr. Matthias Scholl Esq., 14781 Memorial Drive, Suite 1319, Houston, Tex. 77079.

### BACKGROUND OF THE INVENTION

1. Field of the Invention

The invention relates to a rotor assembly, and belongs to a field of a brushless direct current motor (BLDC motor).

2. Description of the Related Art

A conventional rotor assembly of a BLDC motor generally includes a rotor core, a permanent magnet, a magnetic loop bracket, and a magnetic loop. The permanent magnet is mounted on the rotor core, and the magnetic loop is disposed on the magnetic loop bracket. However, a typical magnetic loop bracket is made of aluminum material; the magnetic loop bracket is fixed by rivets. Thus, the assembled rotor has a poor accuracy of the relevant position; the production process is complicated; and the assembly is not convenient.

### SUMMARY OF THE INVENTION

In view of the above-described problems, it is one objective of the invention to provide a rotor assembly that has a simple structure, high accuracy of the relevant position, simplified production process, low production cost, and high assembly efficiency; and the installation is not necessary.

To achieve the above objective, in accordance with one embodiment of the invention, there is provided a rotor assembly, comprising: a permanent magnet; a rotor core, the rotor core comprising: an annular ring comprising a central axial bore, a magnetic induction block comprising a through hole, a radial recess, an end surface, and a bottom surface; a magnetic loop; a magnetic loop bracket; an end plate comprising an end surface; a base plate; and a connecting column A plurality of the magnetic induction blocks protrude outward from an outer side of the annular ring. The radial recess is formed between every two adjacent magnetic induction blocks for mounting the permanent magnet. The end plate and the base plate are disposed on the end surface and the bottom surface of the rotor core by injection molding, respectively. The connecting column passes through the through hole and connects the end plate and the base plate as a whole body. The end surface of the end plate protrudes upward to form the magnetic loop bracket. The magnetic loop is disposed on the magnetic loop bracket.

In a class of this embodiment, the radial recess comprises an opening. The magnetic induction blocks disposed on two sides of the opening protrude with a hook block. An outer plate is disposed inside the opening at an inner side of the hook block by injection molding. The outer plate is connected to the end plate and the bottom plate as a whole body.

In a class of this embodiment, a lug boss is disposed on a middle part of a bottom of the radial recess. Inner plates are disposed on two sides of the lug boss by injection molding. The inner plates are connected to the end plate and the bottom plate as a whole body.

In a class of this embodiment, an outer surface of the magnetic induction block is an exposed curved surface. The outer surface employs a point A with a distance H deviating from a center of the central axial bore as a center O of circle.

In a class of this embodiment, the magnetic loop bracket is in a shape of a ring. A step is arranged on an end part of the magnetic loop bracket. The magnetic loop is disposed on the step.

In a class of this embodiment, a positioning recess is disposed outside the step on an outer side wall of the magnetic loop bracket. An inner side wall of the magnetic loop protrudes inside with a positioning convex block. The positioning convex block matches with the positioning recess for radially fixing the magnetic loop on the magnetic loop bracket.

In a class of this embodiment, an inversed clasp is disposed on an end surface of the magnetic loop bracket. A recess is disposed on the inner side wall of the magnetic loop. The inversed clasp matches the recess for axially fixing the magnetic loop on the magnetic loop bracket.

In a class of this embodiment, cement recesses are disposed on the end plate and the bottom plate, respectively.

In a class of this embodiment, a plurality of stiffeners are disposed on the outer side wall of the magnetic loop bracket.

In a class of this embodiment, the end plate, the bottom plate, the connecting column, the outer plate, the inner plate, and the magnetic loop bracket are connected as a whole body by injection molding.

Advantages of the invention are summarized as follows:
1). The end plate and the base plate are disposed on the end surface and the bottom surface of the rotor core by injection molding, respectively. The connecting column passes through the through hole and connects the end plate and the base plate as a whole body. The end surface of the end plate protrudes upward to form the magnetic loop bracket. The magnetic loop is disposed on the magnetic loop bracket. Thus, the invention has a simple structure, high accuracy of the relevant position, simplified production process, low production cost, and high assembly efficiency; and the installation is not necessary.
2). The magnetic induction blocks disposed on two sides of the opening of radial recess protrude with the hook block. The outer plate is disposed inside the opening at the inner side of the hook block by injection molding. The outer plate is connected to the end plate and the bottom plate as a whole body. The lug boss is disposed on the middle part of the bottom of the radial recess. Inner plates are disposed on two sides of the lug boss by injection molding. The inner plates are connected to the end plate and the bottom plate as a whole body. Thus, the permanent magnets are wrapped by the end plate, the bottom plate, the outer plate, and the inner plate; and the connection between each other are firm.
3). The step is arranged on the end part of the magnetic loop bracket. The magnetic loop is disposed on the step. The positioning recess is disposed outside the step on the outer side wall of the magnetic loop bracket. The inner side wall of the magnetic loop protrudes inside with the positioning convex block. The positioning convex block matches with the positioning recess for radially fixing the magnetic loop on the magnetic loop bracket. The inversed clasp is disposed on the end surface of the magnetic loop bracket. The recess is disposed on the inner side wall of the magnetic loop. The inversed clasp matches the recess for axially fixing the magnetic loop on the magnetic loop bracket. The structure of the invention is reasonably designed and firmly assembled.
4). Cement recesses are disposed on the end plate and the bottom plate, respectively. A cement is placed in the cement recess for correcting a dynamic balance, which is simple and convenient.
5). The end plate, the bottom plate, the connecting column, the outer plate, the inner plate, and the magnetic loop bracket are connected as a whole body by injection molding; thereby simplifying the production process, and lowering the labor cost.

### BRIEF DESCRIPTION OF THE DRAWINGS

FIG. 1 is a stereogram of a rotor assembly of the invention;

FIG. 2 is an exploded view of a rotor assembly of the invention;

FIG. 3 is a front view of a rotor assembly of the invention;

FIG. 4 is a cross-sectional view taken from part A-A of FIG. 3;

FIG. 5 is a lateral view of a rotor assembly of the invention;

FIG. 6 is a cross-sectional view taken from part B-B of FIG. 5; and

FIG. 7 is an enlarged view of part of a rotor core of a rotor assembly of the invention.

### DETAILED DESCRIPTION OF THE EMBODIMENTS

For further illustrating the invention, experiments detailing a rotor assembly are described below combined with the drawings.

### Example 1

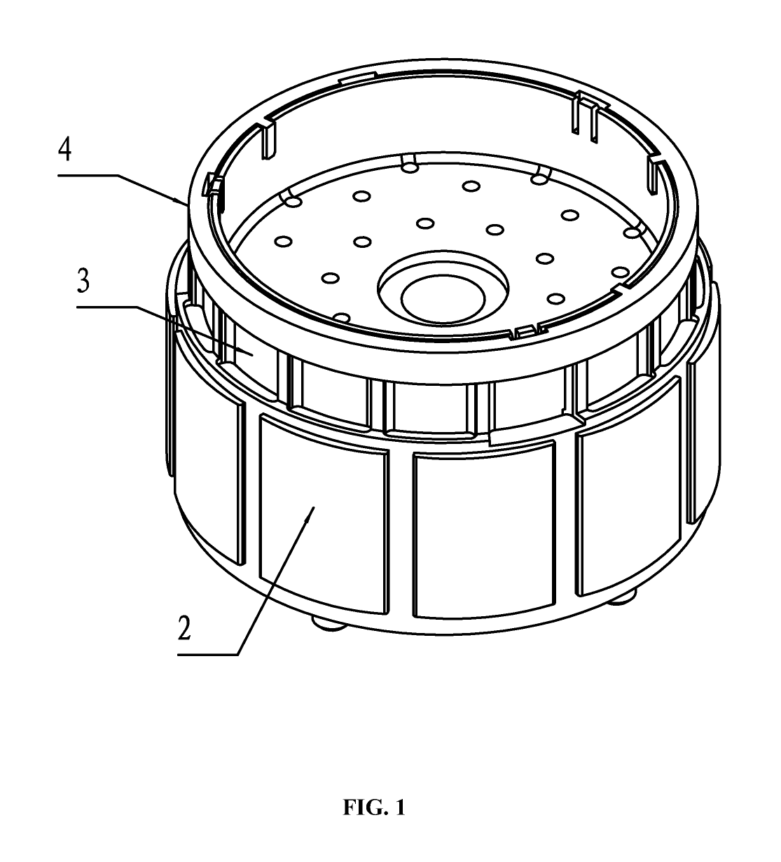

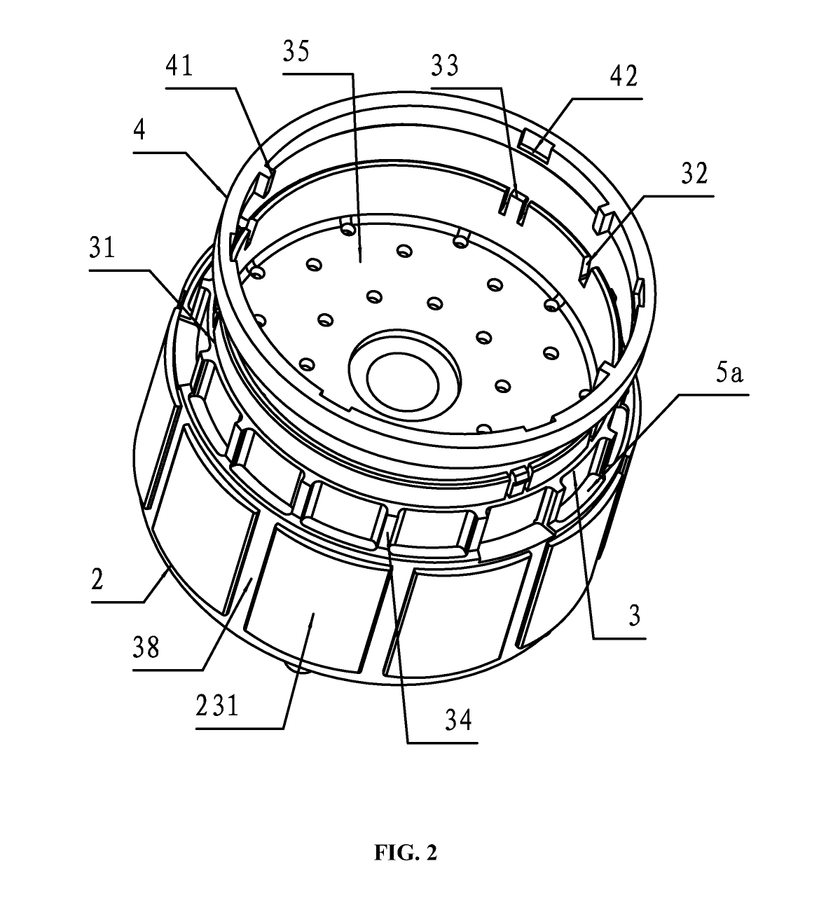

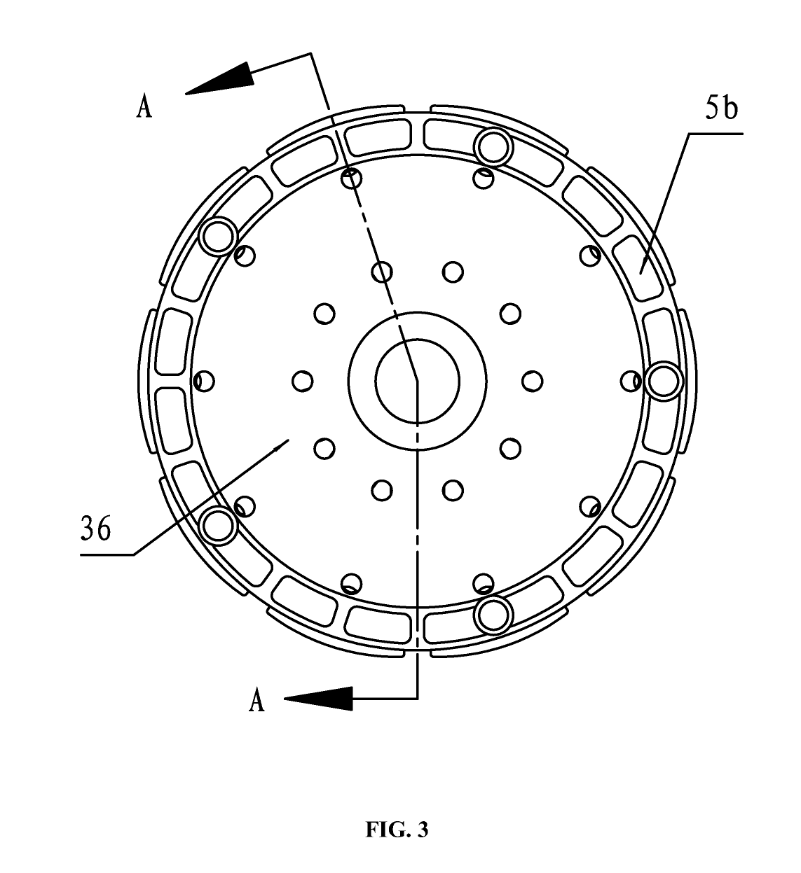

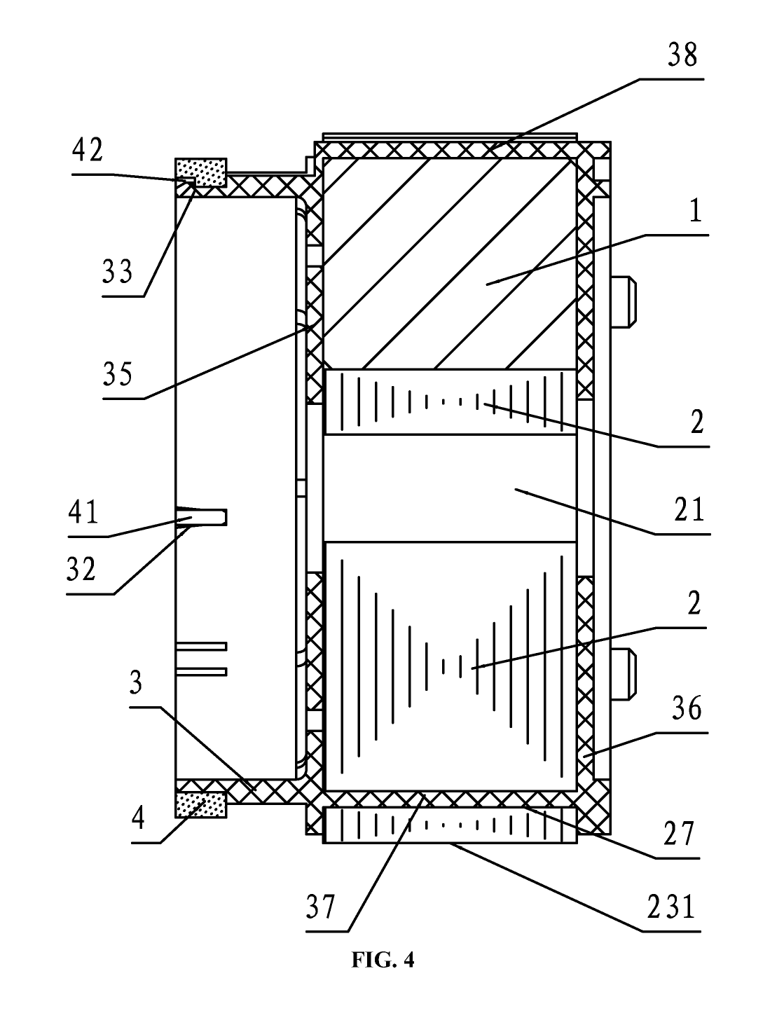

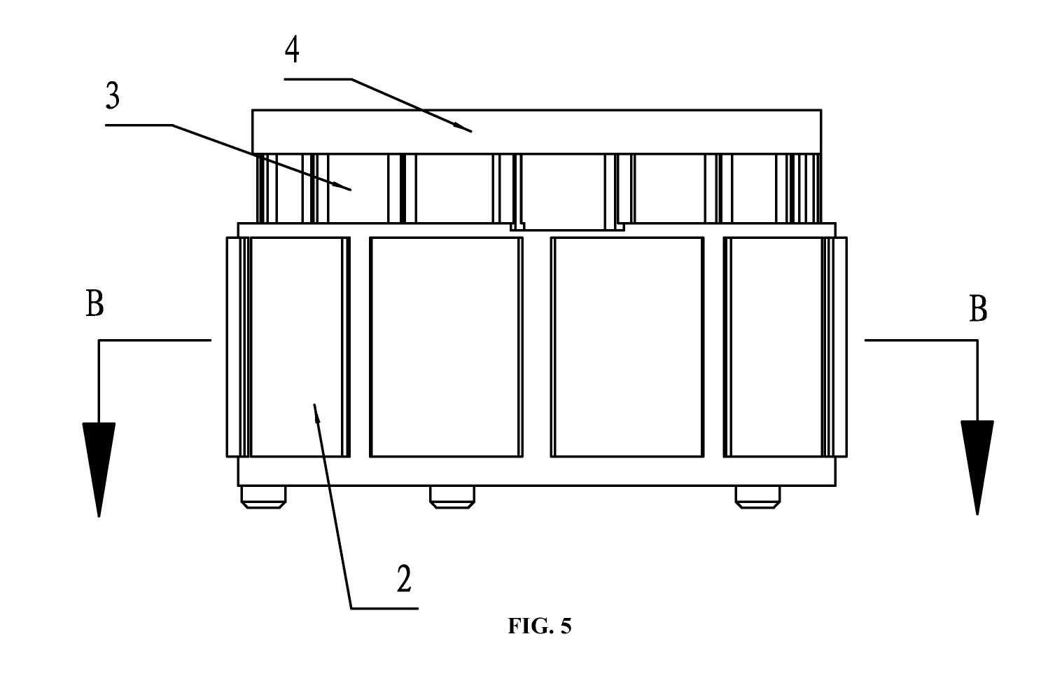

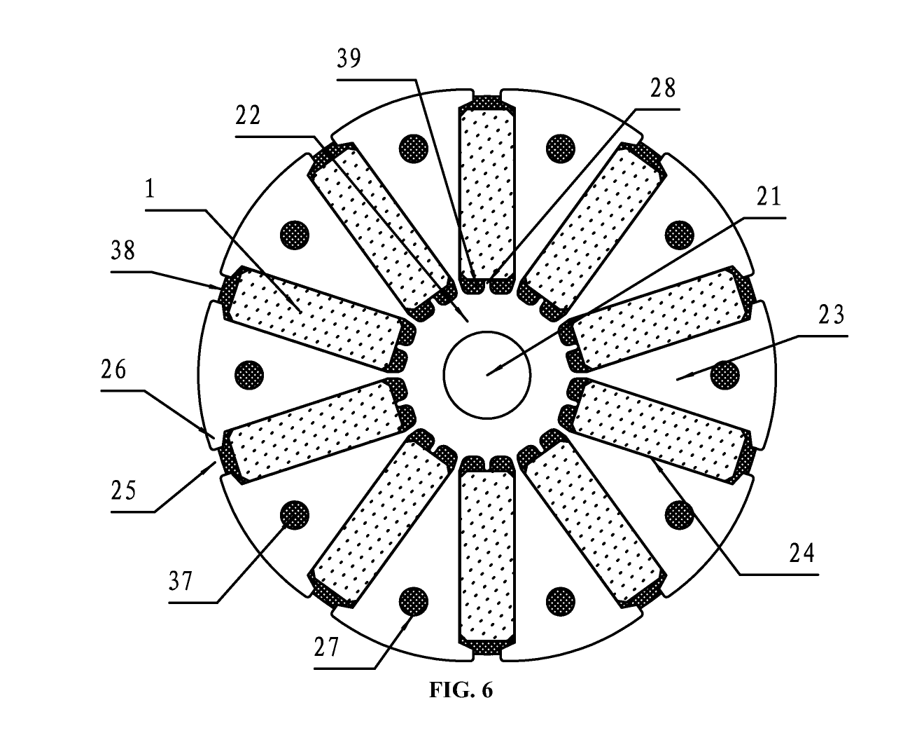

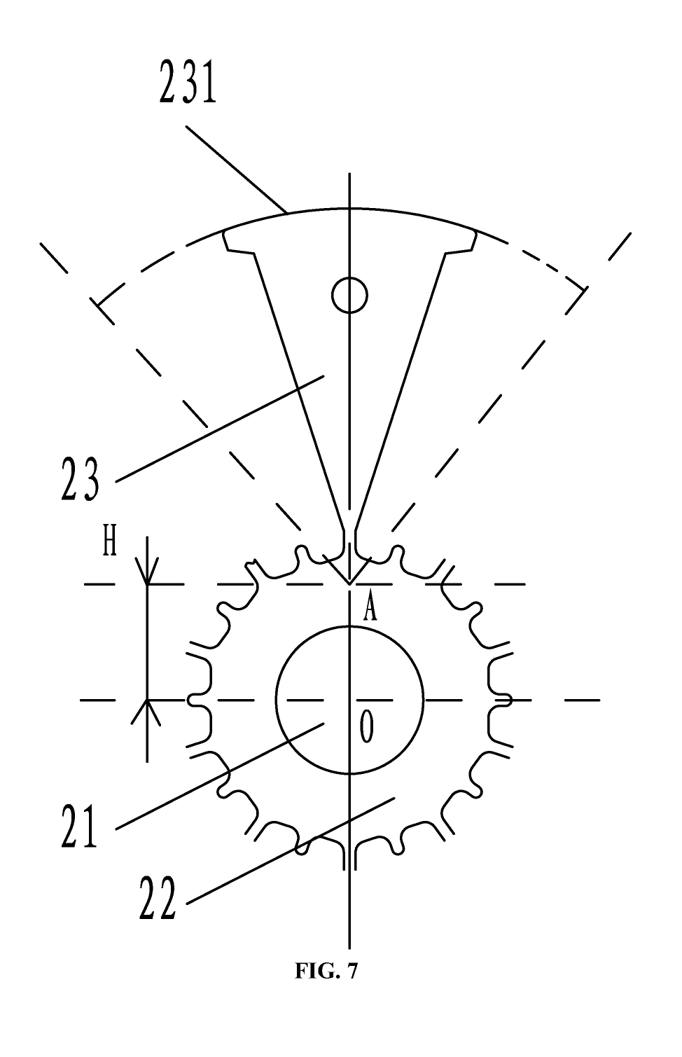

As shown in FIGS. 1-7, a rotor assembly, comprising: a permanent magnet 1; a rotor core 2, the rotor core 2 comprising: an annular ring comprising a central axial bore 21, a magnetic induction block 23 comprising a through hole 27, a radial recess 24, an end surface, and a bottom surface; a magnetic loop 4; a magnetic loop bracket 3; an end plate 35 comprising an end surface; a base plate 36; and a connecting column 37. A plurality of the magnetic induction blocks 23 protrude outward from an outer side of the annular ring 22. The radial recess 24 is formed between every two adjacent magnetic induction blocks 23 for mounting the permanent magnet 1. The end plate 35 and the base plate 36 are disposed on the end surface and the bottom surface of the rotor core 2 by injection molding, respectively. The connecting column 37 passes through the through hole 27 and connects the end plate 35 and the base plate 36 as a whole body. The end surface of the end plate 35 protrudes upward to form the magnetic loop bracket 3. The magnetic loop 4 is disposed on the magnetic loop bracket 3.

### Example 2

Based on Example 1, the following technical features are added: the radial recess 24 comprises an opening 25. The magnetic induction blocks 23 disposed on two sides of the opening 25 protrude with a hook block 26. An outer plate 38 is disposed inside the opening 25 at an inner side of the hook block 26 by injection molding. The outer plate 38 is connected to the end plate 35 and the bottom plate 36 as a whole body.

### Example 3

Based on Example 2, the following technical features are added: a lug boss 28 is disposed on a middle part of a bottom of the radial recess 24. Inner plates 39 are disposed on two sides of the lug boss 28 by injection molding. The inner plates 39 are connected to the end plate 35 and the bottom plate 36 as a whole body.

### Example 4

Based on Example 1, 2, or 3, the following technical features are added: an outer surface 231 of the magnetic induction block 23 is an exposed curved surface. The outer surface 231 employs a point A with a distance H deviating from a center of the central axial bore 21 as a center O of circle.

### Example 5

Based on Example 1, 2, or 3, the following technical features are added: the magnetic loop bracket 3 is in a shape of a ring. A step 31 is arranged on an end part of the magnetic loop bracket 3. The magnetic loop 4 is disposed on the step 31.

### Example 6

Based on Example 5, the following technical features are added: a positioning recess 32 is disposed outside the step 31 on an outer side wall of the magnetic loop bracket 3. An inner side wall of the magnetic loop 4 protrudes inside with a positioning convex block 41. The positioning convex block 41 matches with the positioning recess 32 for radially fixing the magnetic loop 4 on the magnetic loop bracket 3.

### Example 7

Based on Example 6, the following technical features are added: an inversed clasp 33 is disposed on an end surface of the magnetic loop bracket 3. A recess 42 is disposed on the inner side wall of the magnetic loop 4. The inversed clasp 33 matches the recess 42 for axially fixing the magnetic loop 4 on the magnetic loop bracket 3.

### Example 8

Based on Example 1, the following technical features are added: cement recesses 5a, 5b are disposed on the end plate 35 and the bottom plate 36, respectively.

### Example 9

Based on Example 1, the following technical features are added: a plurality of stiffeners 34 are disposed on the outer side wall of the magnetic loop bracket 34.

### Example 10

Based on Example 3, the following technical features are added: the end plate 35, the bottom plate 36, the connecting column 37, the outer plate 38, the inner plate 39, and the magnetic loop bracket 3 are connected as a whole body by injection molding.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

The end plate 35 and the base plate 36 are disposed on the end surface and the bottom surface of the rotor core 2 by injection molding, respectively. The connecting column 37 passes through the through hole 27 and connects the end plate 35 and the base plate 36 as a whole body. The end surface of the end plate 35 protrudes upward to form the magnetic loop bracket 3. The magnetic loop 4 is disposed on the magnetic loop bracket 3. Thus, the invention has a simple structure, high accuracy of the relevant position, simplified production process, low production cost, and high assembly efficiency; and the installation is not necessary.

The invention claimed is:

1. A rotor assembly, comprising:
a) a permanent magnet (1);
b) a rotor core (2), the rotor core (2) comprising: an annular ring comprising a central axial bore (21), a magnetic induction block (23) comprising a through hole (27), a radial recess (24), an end surface, and a bottom surface;
c) a magnetic loop (4);
d) a magnetic loop bracket (3);
e) an end plate (35) comprising an end surface;
f) a base plate (36); and
g) a connecting column (37);
wherein
a plurality of magnetic induction blocks (23) protrude outward from an outer side of the annular ring (22);
the radial recess (24) is formed between every two adjacent magnetic induction blocks (23) for mounting the permanent magnet (1);
the end plate (35) and the base plate (36) are disposed on the end surface and the bottom surface of the rotor core (2) by injection molding, respectively;
the connecting column (37) passes through the through hole (27) and connects the end plate (35) and the base plate (36) as a whole body;
the end surface of the end plate (35) protrudes upward to form the magnetic loop bracket (3); and
the magnetic loop (4) is disposed on the magnetic loop bracket (3).

2. The rotor assembly of claim 1, wherein
the radial recess (24) comprises an opening (25);
the magnetic induction blocks (23) disposed on two sides of the opening (25) protrude with a hook block (26);
an outer plate (38) is disposed inside the opening (25) at an inner side of the hook block (26) by injection molding; and
the outer plate (38) is connected to the end plate (35) and the bottom plate (36) as a whole body.

3. The rotor assembly of claim 2, wherein
a lug boss (28) is disposed on a middle part of a bottom of the radial recess (24);
inner plates (39) are disposed on two sides of the lug boss (28) by injection molding; and
the inner plates (39) are connected to the end plate (35) and the bottom plate (36) as a whole body.

4. The rotor assembly of claim 1, wherein
an outer surface (231) of the magnetic induction block (23) is an exposed curved surface; and
the outer surface (231) employs a point (A) with a distance (H) deviating from a center of the central axial bore (21) as a center (O) of circle.

5. The rotor assembly of claim 2, wherein
an outer surface (231) of the magnetic induction block (23) is an exposed curved surface; and
the outer surface (231) employs a point (A) with a distance (H) deviating from a center of the central axial bore (21) as a center (O) of circle.

6. The rotor assembly of claim 3, wherein
an outer surface (231) of the magnetic induction block (23) is an exposed curved surface; and
the outer surface (231) employs a point (A) with a distance (H) deviating from a center of the central axial bore (21) as a center (O) of circle.

7. The rotor assembly of claim 1, wherein
the magnetic loop bracket (3) is in a shape of a ring;
a step (31) is arranged on an end part of the magnetic loop bracket (3); and
the magnetic loop (4) is disposed on the step (31).

8. The rotor assembly of claim 2, wherein
the magnetic loop bracket (3) is in a shape of a ring;
a step (31) is arranged on an end part of the magnetic loop bracket (3); and
the magnetic loop (4) is disposed on the step (31).

9. The rotor assembly of claim 3, wherein
the magnetic loop bracket (3) is in a shape of a ring;
a step (31) is arranged on an end part of the magnetic loop bracket (3); and
the magnetic loop (4) is disposed on the step (31).

10. The rotor assembly of claim 7, wherein
a positioning recess (32) is disposed outside the step (31) on an outer side wall of the magnetic loop bracket (3);
an inner side wall of the magnetic loop (4) protrudes inside with a positioning convex block (41); and
the positioning convex block (41) matches with the positioning recess (32) for radially fixing the magnetic loop (4) on the magnetic loop bracket (3).

11. The rotor assembly of claim 8, wherein
a positioning recess (32) is disposed outside the step (31) on an outer side wall of the magnetic loop bracket (3);
an inner side wall of the magnetic loop (4) protrudes inside with a positioning convex block (41); and
the positioning convex block (41) matches with the positioning recess (32) for radially fixing the magnetic loop (4) on the magnetic loop bracket (3).

12. The rotor assembly of claim 9, wherein
a positioning recess (32) is disposed outside the step (31) on an outer side wall of the magnetic loop bracket (3);
an inner side wall of the magnetic loop (4) protrudes inside with a positioning convex block (41); and
the positioning convex block (41) matches with the positioning recess (32) for radially fixing the magnetic loop (4) on the magnetic loop bracket (3).

13. The rotor assembly of claim 10, wherein
an inversed clasp (33) is disposed on an end surface of the magnetic loop bracket (3);
a recess (42) is disposed on the inner side wall of the magnetic loop (4); and
the inversed clasp (33) matches the recess (42) for axially fixing the magnetic loop (4) on the magnetic loop bracket (3).

14. The rotor assembly of claim 11, wherein
an inversed clasp (33) is disposed on an end surface of the magnetic loop bracket (3);
a recess (42) is disposed on the inner side wall of the magnetic loop (4); and
the inversed clasp (33) matches the recess (42) for axially fixing the magnetic loop (4) on the magnetic loop bracket (3).

15. The rotor assembly of claim 12, wherein
an inversed clasp (33) is disposed on an end surface of the magnetic loop bracket (3);
a recess (42) is disposed on the inner side wall of the magnetic loop (4); and
the inversed clasp (33) matches the recess (42) for axially fixing the magnetic loop (4) on the magnetic loop bracket (3).

16. The rotor assembly of claim 1, wherein cement recesses (5a, 5b) are disposed on the end plate (35) and the bottom plate (36), respectively.

17. The rotor assembly of claim 1, wherein a plurality of stiffeners (34) are disposed on the outer side wall of the magnetic loop bracket (34).

18. The rotor assembly of claim 3, wherein the end plate (35), the bottom plate (36), the connecting column (37), the outer plate (38), the inner plate (39), and the magnetic loop bracket (3) are connected as a whole body by injection molding.
